(19) United States
(12) Patent Application Publication
(10) Pub. No.: US 2019/0385590 A1
(43) Pub. Date: Dec. 19, 2019

(54) GENERATING DEVICE, GENERATING METHOD, AND NON-TRANSITORY COMPUTER READABLE STORAGE MEDIUM

(71) Applicant: YAHOO JAPAN CORPORATION, Tokyo (JP)

(72) Inventors: Motoi OMACHI, Tokyo (JP); Tran DUNG, Tokyo (JP); Kenichi ISO, Tokyo (JP); Yuya FUJITA, Tokyo (JP)

(73) Assignee: YAHOO JAPAN CORPORATION, Tokyo (JP)

(21) Appl. No.: 16/284,500

(22) Filed: Feb. 25, 2019

(30) Foreign Application Priority Data
Jun. 18, 2018 (JP) 2018-115562

(51) Int. Cl. G10L 15/02; G10L 15/22; G10L 15/06; G10L 15/28; H04R 1/40

(52) U.S. Cl. CPC G10L 15/02; G10L 15/22; H04R 1/406; G10L 15/28; G10L 15/063

(57) ABSTRACT

A generating device according to the present application includes an obtaining unit and a first generating unit. The obtaining unit obtains training data including an acoustic feature value of a first observation signal, a late reverberation component corresponding to the first observation signal, and a phoneme label associated with the first observation signal. The first generating unit generates an acoustic model to identify a phoneme label corresponding to a second observation signal based on the training data obtained by the obtaining unit.

### CROSS-REFERENCE TO RELATED APPLICATION(S)

The present application claims priority to and incorporates by reference the entire contents of Japanese Patent Application No. 2018-115562 filed in Japan on Jun. 18, 2018.

### BACKGROUND OF THE INVENTION

### 1. Field of the Invention

This disclosure invention relates to a generating device, a generating method, and a non-transitory computer readable storage medium.

### 2. Description of the Related Art

Observation signals picked up by a microphone include late reverberation that reaches the microphone after reflecting off floors and walls when predetermined time (for example, 30 milliseconds (mS)) elapses, in addition to direct sound that directly reaches the microphones from a sound source. Such late reverberation can degrade the accuracy of voice recognition significantly. Therefore, to improve the accuracy of voice recognition, techniques have been proposed for removing late reverberation from observation signals. For example, in one technique, a minimum value or a quasi-minimum value of power of an acoustic signal is extracted as a power estimation value of a late reverberation component of the acoustic signal, and an inverse filter to remove late reverberation is calculated based on the extracted power estimation value (Japanese Laid-open Patent Publication No. 2007-65204).

However, in the above conventional technique, it is not necessarily possible to improve the accuracy of voice recognition. Generally, as a distance between a speaker and a microphone increases, an influence of late reverberation increases. However, in the above conventional technique, it is assumed that a power of a later reverberation component is a minimum value or a quasi-minimum value of power of an observation signal. Therefore, there is a case in which late reverberation cannot be removed appropriately with the above conventional technique when a speaker is at a distant position from the microphone.

### SUMMARY OF THE INVENTION

According to one innovative aspect of the subject matter described in this disclosure, A generating device include: (i) an obtaining unit that obtains training data including an acoustic feature value of a first observation signal, a late reverberation component corresponding to the first observation signal, and a phoneme label associated with the first observation signal; and (ii) a first generating unit that generates an acoustic model to identify a phoneme label corresponding to a second observation signal based on the training data obtained by the obtaining unit.

### BRIEF DESCRIPTION OF THE DRAWINGS

FIG. 1 is a diagram showing a configuration example of a network system according to an embodiment;

FIG. 2 is a diagram showing an example of generation processing according to the embodiment;

FIG. 3 is a diagram showing an example of late reverberation;

FIG. 4 is a diagram showing a configuration example of a generating device according to the embodiment;

FIG. 5 is a diagram showing an example of a training-data storage unit according to the embodiment;

FIG. 6 is a flowchart showing a procedure of the generation processing performed by the generating device according to the embodiment;

FIG. 7 is a diagram showing an example of generation processing according to a modification; and

FIG. 8 is a diagram showing an example of a hardware configuration.

### DETAILED DESCRIPTION OF THE PREFERRED EMBODIMENTS

Forms (hereinafter, “embodiments”) to implement a generating device, a generating method, and a non-transitory computer readable storage medium according to the present application are explained in detail below with reference to the drawings. The embodiments are not intended to limit the generating device, the generating method, and the non-transitory computer readable storage medium according to the present application. Moreover, the respective embodiments can be combined appropriately within a range not causing a contradiction in processing. Furthermore, like reference symbols are assigned to like parts throughout the embodiments below, and duplicated explanation is omitted.

1. Configuration of Network System

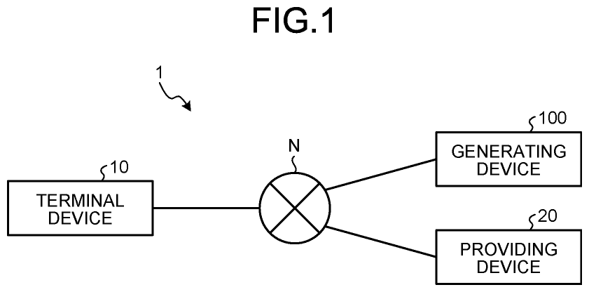

First, a network system 1 according to an embodiment is explained referring to FIG. 1. FIG. 1 is a diagram showing a configuration example of the network system 1 according to the embodiment. As shown in FIG. 1, the network system 1 according to the embodiment includes a terminal device 10, a providing device 20, and a generating device 100. The terminal device 10, the providing device 20, and the generating device 100 are connected to a network N in a wired or wireless manner. Although not illustrated in FIG. 1, more than one unit of the terminal device 10, more than one unit of the providing device 20, and more than one unit of the generating device 100 can be included in the network system 1.

The terminal device 10 is an information processing device that is used by a user. The terminal device 10 can be any type of an information processing device including a smartphone, a smart speaker, a desktop personal computer (PC), a laptop PC, a tablet PC, and a personal digital assistant (PDA).

The providing device 20 is a server device that provides training data to generate an acoustic model. The training data includes, for example, an observation signal picked up by a microphone, a phoneme label associated with the observation signal, and the like.

The generating device 100 is a server device that generates an acoustic model by using the training data to generate an acoustic model. The generating device 100 communicates with the terminal device 10 and the providing device 20 by wired or wireless communication through the network N.

2. Generation Processing

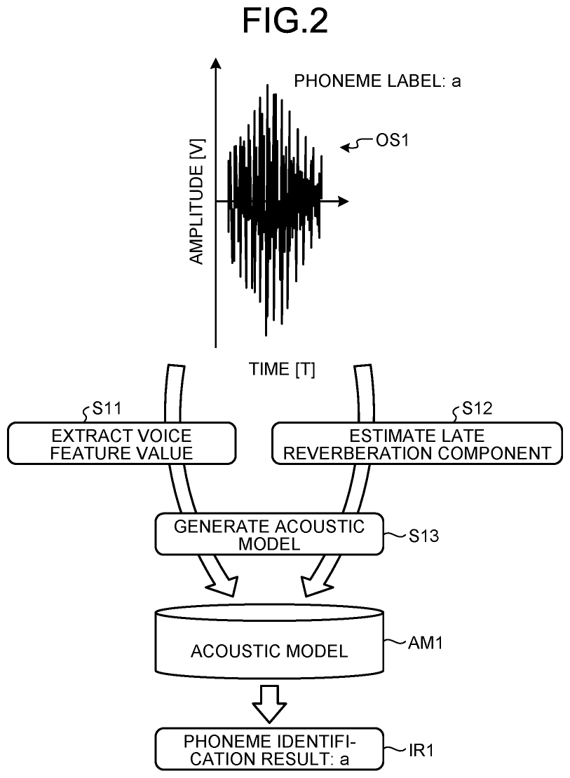

Next, an example of generation processing according to the embodiment is explained referring to FIG. 2. FIG. 2 is a diagram showing an example of the generation processing according to the embodiment.

In the example of FIG. 2, the generating device 100 stores training data provided by the providing device 20. The stored training data includes an observation signal OS1. The observation signal OS1 is a voice signal that is associated with a phoneme label “a”. In other words, the observation signal OS1 is a voice signal of “a”.

First, the generating device 100 extracts a voice feature value from the observation signal OS1 (step S11). More specifically, the generating device 100 calculates a spectrum of a voice frame (also referred to as complex spectrum) from the observation signal OS1 by using the short-time Fourier transform. The generating device 100 applies a filter bank (also referred to as Mel filter bank) to the calculated spectrum and extracts an output of the filter bank as the voice feature value.

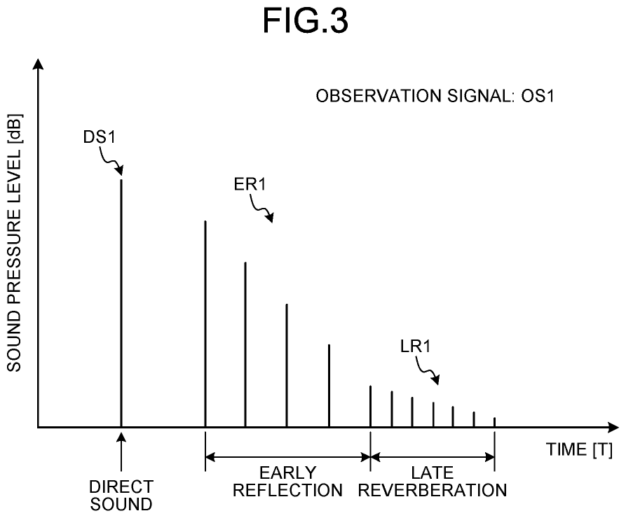

Subsequently, the generating device 100 estimates a late reverberation component of the observation signal OS1 (step S12). This is explained using FIG. 3. FIG. 3 is a diagram showing an example of late reverberation. In the example shown in FIG. 3, the observation signal OS1 includes a direct sound DS1 and early reflection ER1, and late reverberation LR1. A waveform of the observation signal OS1 in FIG. 2 is observed as superimposition of the direct sound DS1, the early reflection ER1, and the late reverberation LR1 in an actual situation. The direct sound DS1 is a voice signal that directly reaches a microphone. The early reflection ER1 is a voice signal that reaches the microphone after reflecting off floors and walls before predetermined time (for example, 30 mS) elapses. The late reverberation is a voice signal that reaches the microphone after reflecting off floors and walls after the predetermined time (for example, 30 mS) elapses.

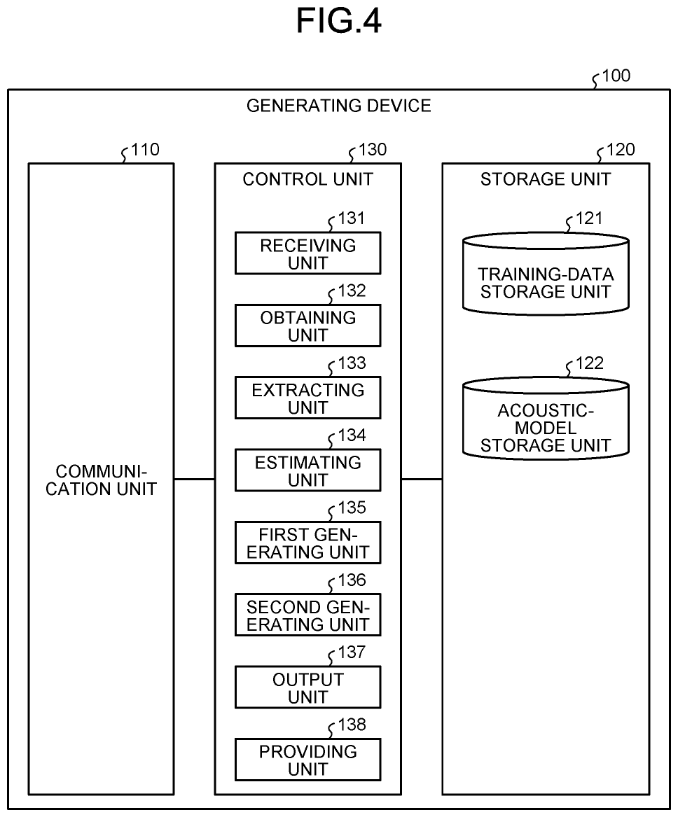

The generating device 100 estimates a late reverberation component of the observation signal OS1, for example, by using a moving average model. More specifically, the generating device 100 calculates a value that is acquired by smoothing spectra of voice frames from an n frames previous voice frame to a predetermined voice frame as a late reverberation component of a predetermined voice frame (n is an arbitrary positive integer). In other words, the generating device 100 approximates a late reverberation component of a predetermined voice frame by a weighted sum of the spectra of the voice frames from the n frames previous to the predetermined voice frame. An exemplary approximate expression of a late reverberation component is described later in relation to FIG. 4.

Referring back to FIG. 2, the generating device 100 generates an acoustic model AM1 based on the extracted voice feature value, the estimated late reverberation component, and the phoneme label “a” (step S13). In an example, the acoustic model AM1 is a deep neural network (DNN) model. In this example, the generating device 100 uses the voice feature value and the late reverberation component as input data of the training data. Moreover, the generating device 100 uses the phoneme label “a” as output data of the training data. The generating device 100 generates the acoustic model AM1 by training the DNN model such that a generalization error is minimized.

The acoustic model AM1 identifies a phoneme to which an observation signal corresponds when the observation signal and an estimated late reverberation component of the observation signal are input to the acoustic model AM1, and outputs a phoneme identification result. In the example shown in FIG. 1, the acoustic model AM1 outputs a phoneme identification result IR1 indicating that a voice signal is “a” when a voice signal “a” and an estimated late reverberation component of the voice signal “a” are input to an input layer of the acoustic model AM1. For example, the acoustic model AM1 outputs a probability (for example, 0.95) of the voice signal being “a” together with a probability (for example, 0.01) of the voice signal being a voice other than “a” (for example, “i”) from an output layer of the acoustic model AM1.

As described above, the generating device 100 according to the embodiment extracts a voice feature value from an observation signal. In addition, the generating device 100 estimates a late reverberation component of the observation signal. The generating device 100 then generates an acoustic model based on the extracted voice feature value, the estimated late reverberation component, and a phoneme label associated with the observation signal. Thus, the generating device 100 can generate an acoustic model enabling to perform voice recognition highly accurately even under a high reverberation environment. For example, when a distance between a speaker and a microphone is large, an influence of late reverberation becomes large. The generating device 100 causes an acoustic model to learn how late reverberation reverberates depending on a distance between a speaker and a microphone, not subtracting a late reverberation component from an observation signal by signal processing. Therefore, the generating device 100 can generate an acoustic model to perform robust voice recognition with respect to late reverberation without generating distortion causing degradation of the voice recognition accuracy. In the following, the generating device 100 that implements such providing processing is explained in detail.

3. Configuration of Generating Device

Next, a configuration example of the generating device 100 according to the embodiment is explained referring to FIG. 4. FIG. 4 is a diagram showing a configuration example of the generating device 100 according to the embodiment. As shown in FIG. 4, the generating device 100 includes a communication unit 110, a storage unit 120, and a control unit 130. The generating device 100 can include an input unit (for example, a keyboard, a mouse, and the like) that accepts various kinds of operations from an administrator or the like that uses the generating device 100, and a display unit (liquid crystal display, or the like) to display various kinds of information.

Communication Unit 110

The communication unit 110 is implemented by, for example, a network interface card (NIC) or the like. The communication unit 110 is connected to a network in a wired or wireless manner, and communicates information with the terminal device 10 and the providing device 20 through the network.

Storage Unit 120

The storage unit 120 is implemented by a semiconductor memory, such as a random access memory (RAM) and a flash memory, or a storage device, such as hard disk and an optical disk. As shown in FIG. 4, the storage unit 120 includes a training-data storage unit 121 and an acoustic-model storage unit 122.

Training-Data Storage Unit 121

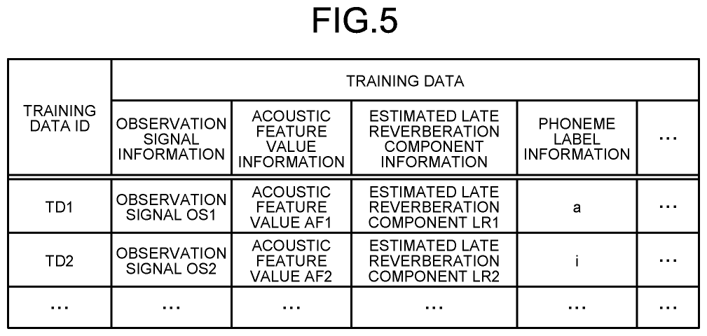

FIG. 5 is a diagram showing an example of the training-data storage unit 121 according to the embodiment. The training-data storage unit 121 stores training data to generate an acoustic model. The training-data storage unit 121 stores, for example, training data that is received by a receiving unit 131. In the example shown in FIG. 5, the training-data storage unit 121 stores “training data” per “training data identification (ID)”. As an example, “training data” includes items of “observation signal”, “acoustic feature value”, “estimated late reverberation component”, and “phoneme label”.

“Training data ID” indicates an identifier to identify training data. “Observation signal information” indicates information relating to an observation signal picked up by a microphone. For example, the observation signal information shows a waveform of an observation signal. “Acoustic feature value” indicates information relating to an acoustic feature value of an observation signal. For example, the acoustic feature value information indicates an output of a filter bank. “Estimated late reverberation component information” indicates information relating to a late reverberation component estimated based on an observation signal. For example, the estimated late reverberation component information indicates a late reverberation component estimated based on a linear estimation model. “Phoneme label information” indicates information relating to a phoneme label corresponding to an observation signal. For example, the phoneme label information indicates a phoneme corresponding to an observation signal.

For example, FIG. 5 shows that an observation signal of training data that is identified by a training data ID “TD1” is the “observation signal OS1”. Moreover, for example, FIG. 5 shows that an acoustic feature value of the training data that is identified by the training data ID “TD1” is an “acoustic feature value AF1”. Furthermore, for example, FIG. 5 shows an estimated late reverberation component of the training data that is identified by the training data ID “TD1” is the “estimated late reverberation component LR1”. Moreover, for example, FIG. 5 shows that the phoneme label of the training data that is identified by the training data ID “TD1” is “a”.

Acoustic-Model Storage Unit 122

Referring back to FIG. 4, the acoustic-model storage unit 122 stores an acoustic model. The acoustic-model storage unit 122 stores, for example, an acoustic model generated by a first generating unit 135.

Control Unit 130

The control unit 130 is a controller, and is implemented, for example, by executing various kinds of programs stored in a storage device in the generating device 100 by a processor, such as a central processing unit (CPU) and a micro-processing unit (MPU), using a RAM or the like as a work area. Moreover, the control unit 130 is a controller, and can be implemented by an integrated circuit, such as an application specific integrated circuit (ASIC) and a field programmable gate array (FPGA). The control unit 130 includes, as shown in FIG. 4, the receiving unit 131, an obtaining unit 132, an extracting unit 133, an estimating unit 134, the first generating unit 135, a second generating unit 136, an output unit 137, and a providing unit 138, and implements or performs functions and actions of information processing explained below. An internal configuration of the control unit 130 is not limited to the configuration shown in FIG. 4, but can be another configuration as long as the configuration enables to perform the information processing described later.

Receiving Unit 131

The receiving unit 131 receives training data to generate an acoustic model from the providing device 20. The receiving unit 131 can store the received training data in the training-data storage unit 121.

The training data includes an observation signal that is picked up by a microphone, and a phoneme label that is associated with the observation signal. The received training data can include an acoustic feature value of the observation signal, and a late reverberation component estimated based on the observation signal. In other words, the receiving unit 131 can receive training data that includes an acoustic feature value of an observation signal, a late reverberation component estimated based on the observation signal, and a phoneme label associated with the observation signal.

As an example, the observation signal is a voice signal that is received through an application provided by the providing device 20. In this example, the application is a voice assistant application that is installed in the terminal device 10 being, for example, a smartphone. In another example, the observation signal is a voice signal that is provided to the providing device 20 from the terminal device 10 being a smart speaker. In these examples, the providing device 20 receives, from the terminal device 10, a voice signal picked up by a microphone mounted on the terminal device 10.

The voice signal received by the providing device 20 is associated with a phenome label that corresponds to text data transcribed from the voice signal. Transcription of voice signal is performed by, for example, a tape transcription technician. As described, the providing device 20 transmits training data that includes a voice signal and a label associated with the voice signal to the generating device 100

Obtaining Unit 132

The obtaining unit 132 obtains or acquires training data to generate an acoustic model. For example, the obtaining unit 132 obtains training data that is received by the receiving unit 131. Moreover, for example, the obtaining unit 132 obtains training data from the training-data storage unit 121.

The obtaining unit 132 obtains or acquires training data that includes an acoustic feature value of a first observation signal, a late reverberation component corresponding to the first observation signal, and a phoneme label associated with the first observation signal. For example, the obtaining unit 132 obtains training data that includes an acoustic feature value of an observation signal (for example, the first observation signal), a late reverberation component that is estimated based on the observation signal, and a phoneme label that is associated with the observation signal.

The obtaining unit 132 obtains or acquires an observation signal from training data. Moreover, the obtaining unit 132 obtains a phoneme label associated with the observation signal from the training data. Furthermore, the obtaining unit 132 obtains an acoustic feature value of the observation signal from the training data. Moreover, the obtaining unit 132 obtains a late reverberation component estimated based on the observation signal from the training data. The obtaining unit 132 can obtain an acoustic model from the acoustic-model storage unit 122.

Extracting Unit 133

The extracting unit 133 extracts a voice feature value from the observation signal obtained by the obtaining unit 132. For example, the extracting unit 133 calculates a frequency component of the observation signal from a signal waveform of the observation signal. More specifically, a spectrum of a voice frame is calculated from the observation signal by using the short-time Fourier transform. Furthermore, by applying a filter bank to the calculated spectrum, the extracting unit 133 extracts an output of the filter bank (that is, an output of a channel of the filter bank) in each voice frame as a voice feature value. The extracting unit 133 can extracts a Mel frequency cepstrum coefficient from the calculated spectrum as a voice feature value. The extracting unit 133 stores the voice feature value extracted from the observation signal in the training-data storage unit 121, associating with the phoneme label associated with the observation signal.

Estimating Unit 134

The estimating unit 134 estimates a late reverberation component based on the observation signal obtained by the obtaining unit 132. Generally, in an environment in which a sound source other than a target sound source and a reflector are present around the target sound source, an observation signal picked up by a microphone includes a direct sound, a noise, and reverberation. That is, the observation signal is a signal (for example, a voice signal, an acoustic signal, and the like) in which a direct sound, a noise, and reverberation are mixed.

The direct sound is sound that directly reaches the microphone. The target sound source is, for example, a user (that is, speaker). In this case, the direct sound is a voice of a user that directly reaches the microphone. The noise is sound that reaches the microphone from a sound source other than the target sound source. The sound source other than the target sound source is, for example, an air conditioner installed in a room in which the user is present. In this case, the noise is sound output from the air conditioner. The reverberation is sound that reaches the reflector from the target sound source, is reflected off the reflector, and then reaches the microphone. The reflector is, for example, a wall of the room in which the user being the target sound source is present. In this case, the reverberation is the voice of the user reflected off the wall of the room.

The reverberation includes early reflection (also referred to as early reflected sound) and a later reverberation (also referred to as late reverberation sound). The early reflection is a reflected sound that reaches the microphone before predetermined time (for example, 30 mS) elapses from when the direct sound reaches the microphone. The early reflection includes a primary reflection that is a reflected sound reflected off the wall once, and a secondary reflection that is a reflected sound reflected off the wall twice, and the like. On the other hand, the late reverberation is a reflected sound that reaches the microphone after the predetermined time (for example, 30 mS) elapses after the direct sound reaches the microphone. The predetermined time can be defined as a cutoff scale. Moreover, the predetermined time can be defined based on time for an energy of the reverberation to attenuate to a predetermined energy.

The estimating unit 134 estimates a late reverberation component of the observation signal. For example, the estimating unit 134 estimates the late reverberation component of the observation signal based on a linear estimation model. The estimating unit 134 stores the late reverberation component estimated based on the observation signal in the training-data storage unit 121, associating with the phoneme label associated with the observation signal.

As one example, the estimating unit 134 estimates the late reverberation component of the observation signal by using a moving average model. In the moving average model, it is assumed that a late reverberation component of a predetermined frame (that is, the voice frame) is what is obtained by smoothing spectra of frames from n frames previous frame to the predetermined frame (n is an arbitrary positive integer). In other words, the late reverberation component is assumed to be a spectrum component that is input with a predetermined delay, and to be a spectrum component of a smoothed observation signal. With this assumption, a late reverberation component A(t, f) is given by a following equation approximately.

A(t,f)=ηΣ_{τ=d}⁰ω(τ)|Y(t−τ−D,f)| (1)

where Y(t, f) is a spectrum component of an “f”-th frequency bin in the “t”-th frame. Note that t is a frame number. Moreover, f is an index of a frequency bin. Furthermore, d is a delay. d is a value determined empirically and is, for example, “7”. Moreover, D is a delay (also called positive offset) that is introduced to skip the early reflection. Furthermore, η is a weighting factor with respect to an estimated late reverberation component. η is a value determined empirically and is, for example, “0.07”. ω(t) is a weight with respect to a past frame that is used at calculation of a late reverberation component. As an example, ω(t) is expressed by an equation of hamming window. In this case, ω(t) is given by a following equation.

$$ω ( t ) = 0.54 - 0.46 cos ( \frac{2 π}{T - 1} ( t - \frac{T}{2} ) ) \qquad ( 2 )$$

where T is a sample number in a window. In another example, ω(t) can be expressed by an equation of a rectangular window or a banning window. As described, the estimating unit 134 can calculate a late reverberation component at a predetermined time approximately by using a linear sum of spectra of past frames.

First Generating Unit 135

The first generating unit 135 generates an acoustic model to identify a phoneme label corresponding to an observation signal (for example, a second observation signal) based on the training data obtained by the obtaining unit 132. The first generating unit 135 can generate an acoustic model to identify a phoneme label string (that is, phoneme string) corresponding to an observation signal based on the training data. The first generating unit 135 can generate an acoustic model to identify a label of a tone corresponding to an observation signal based on the training data. The first generating unit 135 can store the generated acoustic model in the acoustic-model storage unit 122.

The first generating unit 135 can generate an acoustic model based on an acoustic feature value of the first observation signal, a late reverberation component estimated based on the first observation signal, and a phoneme label associated with the first observation signal. In other words, the first generating unit 135 uses the late reverberation component estimated based on the observation signal as supplemental information to improve the accuracy of the voice recognition. As an example, the acoustic model is a DNN model. In another example, the acoustic model is a time delay neural network, a recurrent neural network, a hybrid hidden Markov model multilayer perceptron model, restricted Boltzman machine, a convolutional neural network, or the like.

As an example, the acoustic model is a monophoneme model (also called environment-non-dependent model). In another example, the acoustic model is a triphoneme model (also called environment-dependent phoneme model). In this case, the first generating unit 135 generates an acoustic model to identify a triphoneme label corresponding to the observation signal.

The first generating unit 135 uses the voice feature value of the first observation signal and the late reverberation component estimated based on the first observation signal as input data of the training data. Moreover, the first generating unit 135 uses the phoneme label associated with the first observation signal as output data of the training data. The first generating unit 135 trains the model (for example, DNN model) such that a generalization error is minimized by using an error back-propagation method. As described, the first generating unit 135 generates an acoustic model to identify a phoneme label corresponding to the second observation signal.

Second Generating Unit 136

The second generating unit 136 generates an observation signal having a late reverberation component larger than a second threshold by adding reverberation to the first observation signal, a signal-to-noise ratio of which is lower than a first threshold. For example, the second generating unit 136 generates an observation signal having a late reverberation component larger than the second threshold as a reverberation-added signal by convoluting reverberation impulse responses of various rooms with the first observation signal, the signal-to-noise ratio of which is lower than the first threshold.

Output Unit 137

The output unit 137 inputs the second observation signal and the late reverberation component estimated based on the second observation signal to the acoustic model generated by the first generating unit 135, and thereby outputs a phoneme identification result. For example, the output unit 137 outputs a phoneme identification result indicating that the second observation signal is a predetermined phoneme (for example, “a”). The output unit 137 can output a probability of the second observation signal being a predetermined phoneme. For example, the output unit 137 outputs a posteriori probability that is a probability of a feature vector, vector components of which are the second observation signal and the late reverberation component estimated based on the second observation signal belonging to a class of a predetermined phoneme.

Providing Unit 138

The providing unit 138 provides the acoustic model generated by the first generating unit 135 to the providing device 20 in response to a request from the providing device 20. Moreover, the providing unit 138 provides the phoneme identification result output by the output unit 137 to the providing device 20 in response to a request from the providing device 20.

4. Flow of Generation Processing

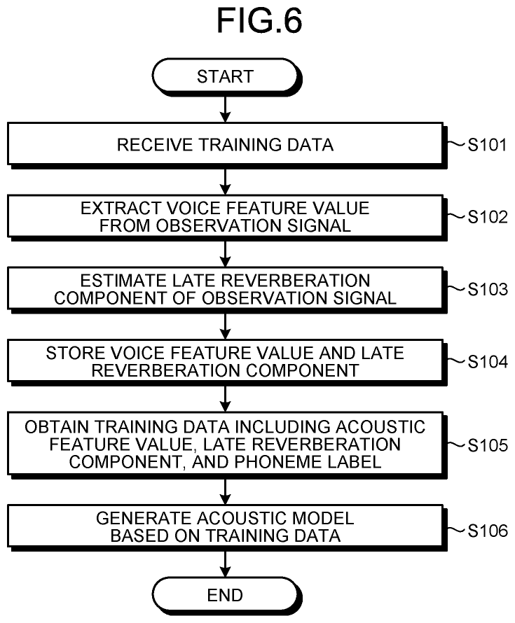

Next, a procedure of generation processing performed by the generating device 100 according to the embodiment is explained. FIG. 6 is a flowchart showing a procedure of the generation processing performed by the generating device 100 according to the embodiment.

As shown in FIG. 6, first, the generating device 100 receives training data to generate an acoustic model from the providing device 20 (step S101). The received training data includes the first observation signal that is picked up by a microphone and a phoneme label that is associated with the first observation signal.

Subsequently, the generating device 100 obtains the first observation signal from the received training data, and extracts a voice feature value from the obtained first observation signal (step S102). For example, the generating device 100 calculates a spectrum from the first observation signal by using the short-time Fourier transform. By applying a filter bank to the calculated spectrum, the generating device 100 extracts an output of each filter bank as the voice feature value.

Subsequently, the generating device 100 estimates a late reverberation component based on the obtained first observation signal (step S103). For example, the generating device 100 estimates the late reverberation component of the first observation signal by using a moving average model. More specifically, the generating device 100 calculates a value that is acquired by smoothing spectra of voice frames from an n frames previous voice frame to a predetermined voice frame as a late reverberation component of a predetermined voice frame (n is an arbitrary positive integer).

Subsequently, the generating device 100 stores the extracted voice feature value and the estimated late reverberation component in the training-data storage unit 121 of the generating device 100, associating with the phoneme label associated with the first observation signal (step S104).

Subsequently, the generating device 100 obtains training data that includes an acoustic feature value of the first observation signal, the late reverberation component corresponding to the first observation signal, and the phoneme label associated with the first observation signal (step S105). For example, the generating device 100 obtains training data that includes an acoustic feature value of the first observation signal, the late reverberation component corresponding to the first observation signal, and the phoneme label associated with the first observation signal from the training-data storage unit 121.

Subsequently, the generating device 100 generates an acoustic model to identify a phoneme label corresponding to the second observation signal based on the obtained training data (step S106). For example, the generating device 100 uses the voice feature value of the first observation signal and the late reverberation component estimated based on the first observation signal as input data of the training data. Moreover, the generating device 100 uses the phoneme label associated with the first observation signal as output data of the training data. The generating device 100 trains a model (for example, DNN model) such that a generalization error is minimized, and thereby generates the acoustic model.

5. Modification

The generating device 100 according to the embodiment described above can be implemented by various other embodiments, in addition to the above embodiment. Therefore, in the following, other embodiments of the generating device 100 described above are explained.

5-1. Acoustic Model Generated from Dry Source and Reverberation-Added Signal

The obtaining unit 132 can obtain an acoustic feature value of the first observation signal, a signal-to-noise ratio of which is lower than the first threshold, a late reverberation component corresponding to the first observation signal, and a phoneme label associated with the first observation signal as training data. In addition, the obtaining unit 132 can obtain an acoustic feature value of an observation signal having a reverberation component larger than the second threshold, a late reverberation component corresponding to the observation signal, and a phoneme label associated with the observation signal as training data.

The first generating unit 135 can generate an acoustic model based on the training data that includes the acoustic feature value of the first observation signal, a signal-to-noise ratio of which is lower than the first threshold. In addition, the first generating unit 135 can generate an acoustic model based on the training data that includes an acoustic feature value of a first signal corresponding to the phoneme label associated with the first observation signal and having a reverberation component larger than the second threshold, and a late reverberation component estimated based on the first signal.

As an example, the first generating unit 135 uses the acoustic feature value of the first observation signal, a signal-to-noise ratio of which is lower than the first threshold and the late reverberation component estimated based on the first observation signal as input data of the training data. Moreover, the first generating unit 135 uses the phoneme label associated with the first observation signal as output data of first training data. Furthermore, the first generating unit 135 generates a first acoustic model by training a model (for example, DNN model). Moreover, the first generating unit 135 uses an acoustic feature value of the first signal corresponding to the phoneme label associated with the first observation signal and having a reverberation component larger than the second threshold and a late reverberation component estimated based on the first signal as input data of second training data. Furthermore, the first generating unit 135 uses the phoneme label associated with the first observation signal as output data of the second training data. The first generating unit 135 generates a second acoustic model by training the first acoustic model. In other words, the first generating unit 135 generates an acoustic model by minibatch learning using the first training data and the second training data.

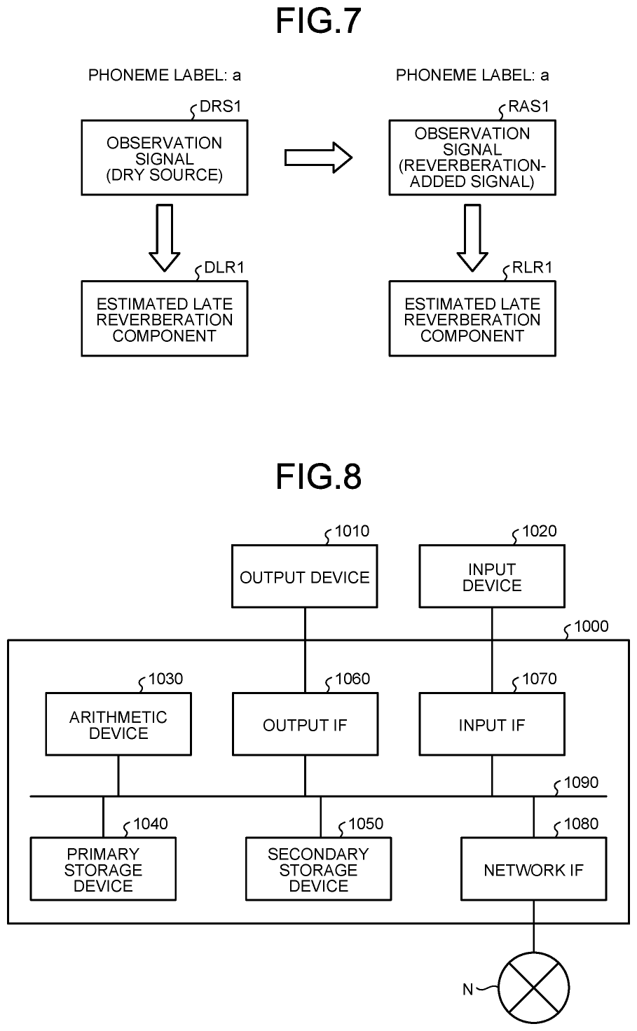

In the following explanation, an acoustic model generated from a dry source and a reverberation-added signal is explained referring to FIG. 7. FIG. 7 is a diagram showing an example of generation processing according to a modification.

First, the extracting unit 133 selects the first observation signal, a signal-to-noise ratio of which is lower than the first threshold from the training data obtained by the obtaining unit 132 as a dry source. In the example shown in FIG. 7, the extracting unit 133 selects a dry source DRS1 that is associated with the phoneme label “a” from the training data.

Subsequently, the second generating unit 136 generates an observation signal having a reverberation component larger than the second threshold by adding reverberation to the first observation signal, the signal-to-noise ratio of which is lower than the first threshold. For example, the second generating unit 136 adds reverberation to the first signal, the signal-to-noise ratio of which is lower than the first threshold, and thereby generates the first signal. In other words, the second generating unit 136 generates the first signal as a reverberation-added signal by adding reverberation to a dry source. In the example shown in FIG. 7, the second generating unit 136 adds reverberation to the dry source DRS1, and thereby generates a reverberation-added signal RAS1. More specifically, the second generating unit 136 generates the reverberation-added signal RAS1 by convoluting reverberation impulse responses of various rooms with the dry source DRS1. As is obvious from generation of the reverberation-added signal RAS1, the reverberation-added signal RAS1 is also associated with the phoneme label “a”. As described, the second generating unit 136 generates a reverberation-added signal in a simulated manner by simulating reverberation of various rooms.

Subsequently, the estimating unit 134 estimates a late reverberation component based on the first observation signal (that is, dry source), a signal-to-noise ratio of which is lower than a threshold. In addition, the estimating unit 134 estimates a late reverberation component based on an observation signal having a reverberation component larger than the second threshold. For example, the estimating unit 134 estimates the late reverberation component based on the generated first signal (that is, reverberation-added signal). In the example shown in FIG. 7, the estimating unit 134 estimates the late reverberation component of the dry source DRS1 as a late reverberation component DLR1 based on the dry source DRS1. In addition, the estimating unit 134 estimates the late reverberation component of the reverberation-added signal RAS1 as a late reverberation component RLR1 based on the reverberation-added signal RAS1.

Subsequently, the first generating unit 135 generates an acoustic model to identify a phoneme label corresponding to the second observation signal. The first generating unit 135 can generate an acoustic model based on the training data that includes an acoustic feature value of the first observation signal, the signal-to-noise ratio of which is lower than a threshold (that is, the dry source). In addition, the first generating unit 135 can generate an acoustic model based on training data that includes an acoustic feature value of the first signal corresponding to the phoneme label associated with the first observation signal and having a reverberation component larger than a threshold (that is, the reverberation-added signal), and the late reverberation component estimated based on the first signal.

In the example shown in FIG. 7, the first generating unit 135 generates an acoustic model based on the training data that includes the acoustic feature value of the dry source DRS1 and the late reverberation component DLR1. In addition, the first generating unit 135 generates an acoustic model based on the training data that includes the acoustic feature value of the reverberation-added signal RAS1 and the late reverberation component RLR1. More specifically, the first generating unit 135 uses the acoustic feature value of the dry source DRS1 and the late reverberation component DLR1 as input data of the training data. In this case, the first generating unit 135 uses the phoneme label “a” as output data of the training data. In addition, the first generating unit 135 uses the acoustic feature value of the reverberation-added signal RAS1 and the late reverberation component RLR1 as input data of the training data. In this case also, the first generating unit 135 uses the phoneme label “a” as output data of the training data. Furthermore, the first generating unit 135 trains a model (for example, DNN model) such that a generalization error is minimized, and thereby generates the acoustic model. As described, the first generating unit 135 can generate an acoustic model based on a set of the training data corresponding to a dry source and the training data corresponding to a reverberation-added signal.

5-2. Signal from which Late Reverberation Component is Removed

The obtaining unit 132 can obtain an acoustic feature value of an observation signal having a late reverberation component smaller than a third threshold, a late reverberation component corresponding to the observation signal, and a phoneme label associated with the observation signal as training data. The second generating unit 136 can generate an observation signal having a late reverberation component smaller than the third threshold by removing a late reverberation component from the first observation signal. The first generating unit 135 can generate an acoustic model based on training data that includes the acoustic feature value of the observation signal corresponding to the phoneme label associated with the first observation signal, and having the late reverberation component smaller than the third threshold, and on the late reverberation component estimated based on the second signal.

For example, the second generating unit 136 generates an observation signal having a late reverberation component smaller than the third threshold as the second signal. As an example, the second generating unit 136 subtracts a late reverberation component estimated by the estimating unit 134 from the first observation signal by using the spectral subtraction method. As described, the second generating unit 136 generates the second signal having a late reverberation component smaller than the third threshold from the first observation signal. As is obvious from generation of the second signal, the second signal is also associated with the phoneme label associated with the first observation signal. The first generating unit 135 then generates an acoustic model based on training data that includes the acoustic feature value of the generated second signal and the late reverberation component estimated based on the generated second signal.

5-3. Signal Including Noise

The obtaining unit 132 can obtain an acoustic feature value of an observation signal, a signal-to-noise ratio of which is higher than a fourth threshold, a late reverberation component corresponding to the observation signal, and a phoneme label associated with the observation signal as training data.

The first generating unit 135 can generate an acoustic model based on the training data that includes the acoustic feature value of the observation signal corresponding to the phoneme label associated with the first observation signal and having the signal-to-noise ratio higher than the fourth threshold, and the late reverberation component estimated based on the observation signal.

As an example, the obtaining unit 132 selects an observation signal, the signal-to-noise ratio of which is higher than a threshold from the training data stored in the training-data storage unit 121 as a third observation signal. Subsequently, the first generating unit 135 generates an acoustic model based on training data that includes an acoustic feature value of the selected third observation signal and a late reverberation component estimated based on the selected third observation signal.

The second generating unit 136 can generate the third observation signal corresponding to the phoneme label associated with the first observation signal, and having the signal-to-noise ratio higher than the threshold by superimposing a noise on the first observation signal. Subsequently, the first generating unit 135 can generate an acoustic model based on training data that includes an acoustic feature value of the generated third observation signal, and the late reverberation component estimated based on the generated third observation signal.

5-4. Others

Moreover, out of the respective processing explained in the above embodiment, part of the processing explained as to be performed automatically can be performed manually also, or all or part of the processing explained as to be performed manually can be performed automatically also by a publicly-known method. In addition, the processing procedures, the specific names, and the information including various kinds of data and parameters explained in the above document and the drawings can be arbitrarily modified unless otherwise specified. For example, the various kinds of information shown in the respective drawings are not limited to the information shown therein.

Furthermore, the illustrated respective components of the respective devices are of functional concept, and it is not necessarily required to be configured physically as illustrated. That is, specific forms of distribution and integration of the respective devices are not limited to the ones illustrated, and all or part thereof can be configured to be distributed or integrated functionally or physically in arbitrary units according to various kinds of loads, usage conditions, and the like.

For example, part of all of the storage unit 120 shown in FIG. 4 can be held by a storage server or the like, not by the generating device 100. In this case, the generating device 100 obtains various kinds of information, such as training data and acoustic models, by accessing the storage server.

5-5. Hardware Configuration

Furthermore, the generating device 100 according to the embodiment described above is implemented by a computer 1000 having a configuration as shown in FIG. 8, for example. FIG. 8 is a diagram showing an example of a hardware configuration. The computer 1000 is connected to an output device 1010 and an input device 1020, and has a configuration in which an arithmetic device 1030, a primary storage device 1040, a secondary storage device 1050, an output interface (IF) 1060, an input IF 1070, and a network IF 1080 are connected one another through a bus 1090.

The arithmetic device 1030 operates based on a program stored in the primary storage device 1040 or the secondary storage device 1050, or a program read from the input device 1020, and performs various kinds of processing. The primary storage device 1040 is a memory device that primarily stores data to be used in various kinds of arithmetic operation by the arithmetic device 1030, such as a RAM. Moreover, the secondary storage device 1050 is a storage device in which data to be used in various kinds of arithmetic operation by the arithmetic device 1030 or various kinds of databases are stored, and is implemented by a ROM, an HDD, a flash memory, or the like.

The output IF 1060 is an interface to transmit information to be output to the output device 1010 that outputs various kinds of information, such as a monitor and a printer, and is implemented by a connector of a USB, a digital visual interface (DVI), or a high definition multimedia interface (HDMI) (registered trademark) standard. Furthermore, the input IF 1070 is an interface to receive information from the various kinds of input device 1020, such as a mouse, a keyboard, and a scanner, and is implemented by a universal serial bus (USB), or the like.

The input device 1020 can also be a device that reads information from an optical recording medium, such as a compact disc (CD), digital versatile disc (DVD), and a phase change rewritable disk (PD), a magneto-optical recording medium, such as a magneto-optical disk (MO), a tape medium, a magnetic recording medium, a semiconductor memory, and the like. Moreover, the input device 1020 can be an external storage medium, such as a USB memory.

The network IF 1080 receives data from another device through a network N and sends it to the arithmetic device 1030, and transmits data generated by the arithmetic device 1030 to another device through the network N.

The arithmetic device 1030 controls the output device 1010 and the input device 1020 through the output IF 1060 and the input IF 1070. For example, the arithmetic device 1030 loads a program on the primary storage device 1040 from the input device 1020 or the secondary storage device 1050, and executes the loaded program.

For example, when the computer 1000 functions as the generating device 100, the arithmetic device 1030 of the computer 1000 implements the function of the control unit 130 by executing a program loaded on the primary storage device 1040.

6. Effect

As described above, the generating device 100 includes the obtaining unit 132 and the first generating unit 135. The obtaining unit 132 obtains training data that includes the acoustic feature value of the first observation signal, the late reverberation component corresponding to the first observation signal, and the phoneme label associated with the first observation signal. The first generating unit 135 generates an acoustic model to identify a phoneme label corresponding to the second observation signal based on the training data obtained by the obtaining unit 132. Therefore, the generating device 100 can generate an acoustic model to perform robust voice recognition with respect to late reverberation under various environments.

Moreover, in the generating device 100 according to the embodiment, the obtaining unit 132 obtains the acoustic feature value of the first observation signal, the signal-to-noise ratio of which is lower than the first threshold, the late reverberation component corresponding to the first observation signal, and the phoneme label associated with the first observation signal as training data. Therefore, the generating device 100 can generate an acoustic model to perform robust voice recognition with respect to late reverberation under a small noise environment.

Furthermore, in the generating device according to the embodiment, the obtaining unit 132 obtains the acoustic feature value of an observation signal having a late reverberation component larger than the second threshold, the late reverberation component corresponding to the observation signal, and the phoneme label associated with the observation signal as training data. Therefore, the generating device 100 can generate an acoustic model to perform robust voice recognition with respect to late reverberation under various environments with reverberations.

Moreover, the generating device according to the embodiment includes the second generating unit 136 that generates an observation signal having a reverberation component larger than the second threshold by adding reverberation to the first observation signal, the signal-to-noise ratio of which is lower than the first threshold. Therefore, the generating device 100 can improve the accuracy of the acoustic model while generating a voice signal under various reverberation environments in a simulated manner.

Furthermore, in the generating device 100 according to the embodiment, the obtaining unit 132 obtains the acoustic feature value of an observation signal having a late reverberation component smaller than the third threshold, the late reverberation component corresponding to the observation signal, and the phoneme label associated with the observation signal as training data. Therefore, the generating device 100 can improve the accuracy of the acoustic model by causing the acoustic model to learn how a late reverberation reverbs under an environment with little late reverberation.

Moreover, the generating device 100 according to the embodiment, the second generating unit 136 generates an observation signal having a late reverberation component smaller than the third threshold by removing the late reverberation component from the first observation signal. Therefore, the generating device 100 can improve the accuracy of an acoustic model while generating a voice signal under an environment with little late reverberation component in a simulated manner.

Furthermore, in the generating device 100 according to the embodiment, the obtaining unit 132 obtains the acoustic feature value of an observation signal, the signal-to-noise ratio of which is higher than the fourth threshold, the late reverberation component corresponding to the observation signal, and the phoneme label associated with the observation signal as training data. Therefore, the generating device 100 can improve the accuracy of the acoustic model by causing the acoustic model to learn how late reverberation reverbs under an environment with noise.

Some of embodiments of the present application have been explained in detail above, but these are examples and the present invention can be implemented by other embodiments in which modifications and improvements are made in various parts including forms described in a section of disclosure of the invention based on knowledge of those skilled in the art.

Moreover, the generating device 100 described above can be implemented by multiple server computers, and some functions can be implemented by calling an external platform or the like by an application programming interface (API), network computing, or the like, and the configuration can be flexibly changed as such.

Furthermore, “unit” described above can be replaced with “means”, “circuit”, or the like. For example, the receiving unit can be replaced with a receiving means or a receiving circuit.

According to one aspect of the embodiment, an effect of improving the accuracy of voice recognition is produced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A generating device comprising:
an obtaining unit that obtains training data including an acoustic feature value of a first observation signal, a late reverberation component corresponding to the first observation signal, and a phoneme label associated with the first observation signal; and
a first generating unit that generates an acoustic model to identify a phoneme label corresponding to a second observation signal based on the training data obtained by the obtaining unit.

2. The generating device according to claim 1, wherein
the obtaining unit obtains an acoustic feature value of the first observation signal, a signal-to-noise ratio of which is lower than a first threshold, a late reverberation component corresponding to the first observation signal, and a phoneme label associated with the first observation signal as the training data.

3. The generating device according to claim 1, wherein
the obtaining unit obtains an acoustic feature value of an observation signal having a reverberation component larger than a second threshold, a late reverberation component corresponding to the observation signal, and a phoneme label associated with the observation signal as the training data.

4. The generating device according to claim 1, further comprising
a second generating unit that generates an observation signal having a reverberation component larger than a second threshold by adding reverberation to the first observation signal, a signal-to-noise ratio of which is lower than a first threshold.

5. The generating device according to claim 1, wherein
the obtaining unit obtains an acoustic feature value of an observation signal having a late reverberation component smaller than a third threshold, the late reverberation component corresponding to the observation signal, and a phoneme label associated with the observation signal as the training data.

6. The generating device according to claim 4, wherein
the second generating unit generates an observation signal having a late reverberation component smaller than a third threshold by removing the late reverberation component from the first observation signal.

7. The generating device according to claim 1, wherein
the obtaining unit obtains an acoustic feature value of an observation signal, a signal-to-noise ratio of which is higher than a fourth threshold, a late reverberation component corresponding to the observation signal, and a phoneme label associated with the observation signal as the training data.

8. A generating method comprising:
obtaining training data including an acoustic feature value of a first observation signal, a late reverberation component corresponding to the first observation signal, and a phoneme label associated with the first observation signal; and
generating an acoustic model to identify a phoneme label corresponding to a second observation signal based on the obtained training data.

9. A non-transitory computer readable storage medium having stored therein a computer program that causes a computer to execute:
obtaining training data including an acoustic feature value of a first observation signal, a late reverberation component corresponding to the first observation signal, and a phoneme label associated with the first observation signal; and
generating an acoustic model to identify a phoneme label corresponding to a second observation signal based on the obtained training data.
